(19) United States
(12) Patent Application Publication
(10) Pub. No.: US 2011/0141097 A1
(43) Pub. Date: Jun. 16, 2011

(54) ORGANIC LIGHT EMITTING DISPLAY DEVICE AND DRIVING VOLTAGE CORRECTION METHOD THEREOF

(76) Inventors: Yoon-Young Lee, Yongin-City (KR); Su-Yeon Yun, Yongin-City (KR)

(21) Appl. No.: 12/876,062

(22) Filed: Sep. 3, 2010

(30) Foreign Application Priority Data
Dec. 11, 2009 (KR) 10-2009-0123105

(51) Int. Cl. G09G 5/00; G09G 3/30

(52) U.S. Cl. 345/212; 345/76

(57) ABSTRACT

An organic light emitting display device is capable of post-correcting driving voltages for driving a panel of the display device after a manufacturing process of the display device has been completed. The display device includes: a display unit including pixels located at crossing regions of scan lines and data lines; a scan driver for supplying scan signals to the scan lines; a data driver for supplying data signals to the data lines; a timing controller for controlling the scan and data drivers; and a power supply for supplying driving voltage to the display unit, the scan and data drivers, and the timing controller. The power supply generates driving voltages for the display unit, the scan and data drivers, and the timing controller by using input power, corrects the driving voltages by accessing offset values stored during testing of the generation of the driving voltages, and outputs the corrected driving voltages.

### CROSS-REFERENCE TO RELATED APPLICATION(S)

This application claims priority to and the benefit of Korean Patent Application No. 10-2009-0123105, filed in the Korean Intellectual Property Office on Dec. 11, 2009, the entire content of which is incorporated herein by reference.

### BACKGROUND

1. Field

Aspects of embodiments according to the present invention relate to an organic light emitting display device and a driving voltage correction method thereof.

2. Description of Related Art

An organic light emitting display device is a type of flat panel display device using an organic compound as a light emitting material. The organic light emitting display device is expected to be used in various display apparatuses including portable display devices because it has excellent luminance and color purity, is thin and lightweight, and is drivable with low amounts of power compared to other similar devices.

With organic light emitting display devices, the image quality of a completed product may not reach expected levels due to factors such as variation in manufacturing processes, etc. For example, when the driving voltages of a display panel generated by a power supply do not reach the target values, the image quality may deteriorate.

When the image quality of a manufactured product does not reach expected levels, the product is judged as bad. Therefore, even for manufactured organic light emitting display devices, a method for improving the manufacturing yield by post-correcting the driving voltages of the devices to more suitable values is desirable.

### SUMMARY

Accordingly, aspects of embodiments of the present invention provide for an organic light emitting display device and a driving voltage correction method thereof capable of post-correcting driving voltages used for driving such display panels after their manufacture.

According to an exemplary embodiment of the present invention, an organic light emitting display device is provided. The organic light emitting display device includes a display unit, a scan driver, a data driver, and a power supply. The display unit includes a plurality of pixels located at crossing regions of scan lines and data lines. The scan driver is configured to supply scan signals to the scan lines. The data driver is configured to supply data signals to the data lines. The timing controller is configured to control the scan driver and the data driver. The power supply is configured to supply a plurality of driving voltages to the display unit, the scan driver, the data driver, and the timing controller. The power supply is further configured to use input power to generate the plurality of driving voltages by: using the input power to generate an uncorrected driving voltage; correcting the uncorrected driving voltage by using an offset value stored during testing of the driving voltage generation, to generate a corrected driving voltage; and outputting the corrected driving voltage.

The power supply may include a voltage generation register, a memory unit, and a correction unit. The voltage generation register is configured to use the input power to generate the plurality of driving voltages. The memory unit is configured to store the offset value. The correction unit is configured to access the memory unit to correct and output one or more of the driving voltages generated in the voltage generation register.

The voltage generation register may be further configured to use the input power to generate a first reference voltage, and to use the first reference voltage to generate a second reference voltage of a ladder resistance, a gate high-level voltage, and a gate low-level voltage for generating gray-scale voltages. The memory unit may be further configured to store an offset value for the first reference voltage.

The correction unit may be further configured to use the offset value for the first reference voltage to correct the first reference voltage, and to supply the corrected first reference voltage to the voltage generation register. The voltage generation register may be further configured to use the corrected first reference voltage to generate the second reference voltage of the ladder resistance, the gate high-level voltage, and the gate low-level voltage.

The voltage generation register may be further configured to use the first reference voltage to generate a third reference voltage, and thereafter to use the third reference voltage to generate the second reference voltage of the ladder resistance. The memory unit may be further configured to store an offset value for the third reference voltage.

The correction unit may be further configured to use the offset value for the third reference voltage to correct the third reference voltage, and thereafter to supply the corrected third reference voltage to the voltage generation register. The voltage generation register may be further configured to use the corrected third reference voltage to generate the second reference voltage of the ladder resistance.

The memory unit may be further configured to store offset values for the gate high-level voltage and the gate low-level voltage.

The correction unit may be further configured to use the offset values for the gate high-level voltage and the gate low-level voltage to correct the gate high-level voltage and the gate low-level voltage generated in the voltage generation register, and to output the corrected gate high-level voltage and the corrected gate low-level voltage to the scan driver.

According to another exemplary embodiment of the present invention, a driving voltage correction method of an organic light emitting display device is provided. The correction method includes measuring a first reference voltage generated from an input power, comparing a target value of the first reference voltage with the measured value of the first reference voltage and setting an offset value corresponding thereto, storing the offset value, correcting the first reference voltage by applying the offset value, and generating driving voltage of a panel by using the corrected first reference voltage.

The third reference voltage may be generated by using the corrected first reference voltage, and a second reference voltage of a ladder resistance for generating gray-scale voltages may be generated by using the third reference voltage.

The correction method may further include measuring the third reference voltage, comparing a target value of the third reference voltage with the measured value of the third reference voltage and setting an offset value for the third reference voltage, correcting the third reference voltage by applying the offset value for the third reference voltage, and generating the second reference voltage of the ladder resistance by using the corrected third reference voltage.

A gate high-level voltage and a gate low-level voltage may be generated by using the corrected first reference voltage.

The correction method may further include measuring the gate high-level voltage and the gate low-level voltage, comparing target values of the gate high-level voltage and the gate low-level voltage with the measured values of the gate high-level voltage and the gate low-level voltage and setting offset values for the gate high-level voltage and the gate low-level voltage, and correcting and outputting the gate high-level voltage and the gate-low level voltage by applying the offset values for the gate high-level voltage and the gate low-level voltage.

According to aspects of embodiments of the present invention, an organic light emitting display device and a driving voltage correction method thereof measure the driving voltages of an organic light emitting display device after manufacture is completed, and post-correct the driving voltages by applying offset values to allow the driving voltages to reach target values. As a result, image quality is improved, thereby improving manufacturing yield.

### BRIEF DESCRIPTION OF THE DRAWINGS

The accompanying drawings, together with the specification illustrate exemplary embodiments of the present invention, and, together with the description, serve to explain the principles of embodiments of the present invention.

FIG. 1 is a block diagram showing an organic light emitting display device according to an embodiment of the present invention;

FIG. 2 is a block diagram showing one example of a power supply and a voltage correction device for correcting driving voltages generated by the power supply according to an embodiment of the present invention;

FIG. 3 is a diagram exemplarily showing steps of generating driving voltages in a voltage generation register shown in FIG. 2; and

FIG. 4 is a flowchart that shows a driving voltage correction method of an organic light emitting display device according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” or “coupled to” another element, it can be directly connected to the another element or be indirectly connected to the another element with one or more intervening elements interposed therebetween. Hereinafter, like reference numerals refer to like elements.

Hereinafter, embodiments of the present invention will be described in more detail with reference to the accompanying drawings.

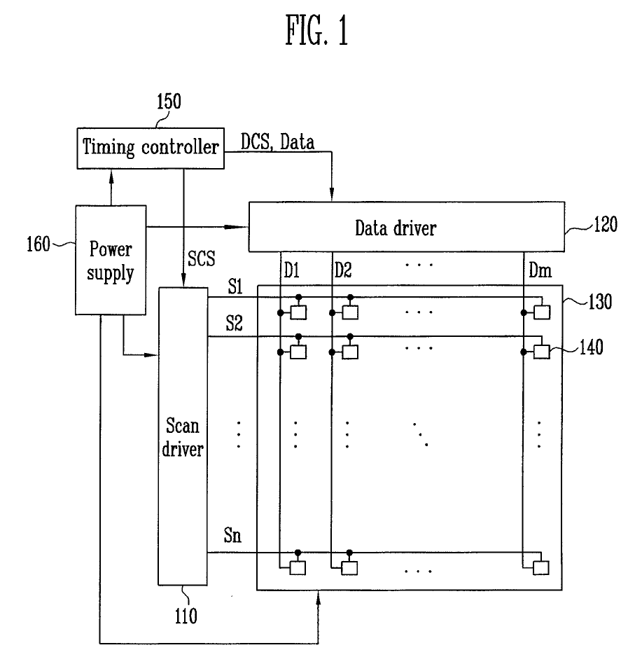

FIG. 1 is a block diagram showing an organic light emitting display device according to an embodiment of the present invention.

Referring to FIG. 1, the organic light emitting display device includes a display unit 130 that includes a plurality of pixels 140 that are positioned at crossing regions of scan lines S1 to Sn and data lines D1 to Dm, a scan driver 110 for supplying scan signals to the scan lines S1 to Sn, a data driver 120 for supplying data signals to the data lines D1 to Dm, a timing controller 150 for controlling the scan driver 110 and the data driver 120, and a power supply 160 for supplying driving voltages to the display unit 130, the scan driver 110, the data driver 120, and the timing controller 150.

The display unit 130 receives the scan signals, the data signals, and pixel power from the scan driver 110, the data driver 120, and the power supply 160, respectively, and displays an image corresponding thereto. Here, the pixel power may include high-potential pixel power ELVDD and low-potential pixel power ELVSS and may further include initialization power VINIT depending on the structure of the pixels 140.

The scan driver 110 receives scan driving control signals SCS from the timing controller 150 and generates the scan signals corresponding thereto. The scan driver 110 sequentially supplies the generated scan signals to the scan lines S1 to Sn.

The data driver 120 receives data driving control signals DCS and data Data from the timing controller 150 and generates the data signals corresponding thereto. The data driver 120 supplies the generated data signals to the data lines D1 to Dm.

The timing controller 150 generates the data driving control signals DCS and the scan driving control signals SCS corresponding to synchronization signals supplied from the outside. The data driving control signals DCS generated in the timing controller 150 are supplied to the data driver 120 and the scan driving control signals SCS are supplied to the scan driver 110. In addition, the timing controller 150 supplies the data Data supplied from the outside to the data driver 120.

The power supply 160 is supplied with input power from, for example, a mobile phone set and generates various driving voltages for driving a display panel by using the input power. The driving voltages generated in the power supply 160 are supplied to the display unit 130, the scan driver 110, the data driver 120, and the timing controller 150.

However, according to an embodiment of the present invention, the power supply 160 corrects the driving voltages and outputs the corrected driving voltages by applying offset values. The offset values are determined and stored during testing of the display device while testing the generation of one or more driving voltages. In particular, the power supply 160 may selectively correct and output driving voltages (e.g., predetermined driving voltages) that influence image quality or reference voltages for generating the predetermined driving voltages.

The correction of the driving voltages may be achieved by post-correcting the driving voltages so that the driving voltages reach target values. This can be accomplished, for example, by measuring driving voltages generated in an organic light emitting display device having the desired image quality after manufacture. Then reference voltages for generating the desired driving voltages can be determined. Consequently, when the driving voltages or the reference voltages do not reach the target values, offset values for correcting deviations between the values can be set and stored in the display device.

When the driving voltages are post-corrected, the image quality of the organic light emitting display device can be improved even after the manufacturing process is completed, thereby improving manufacturing yield.

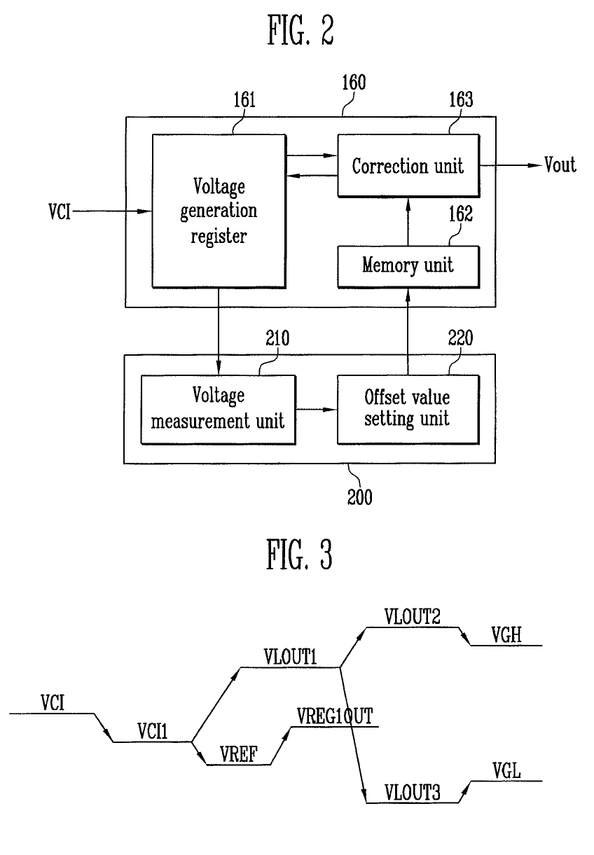

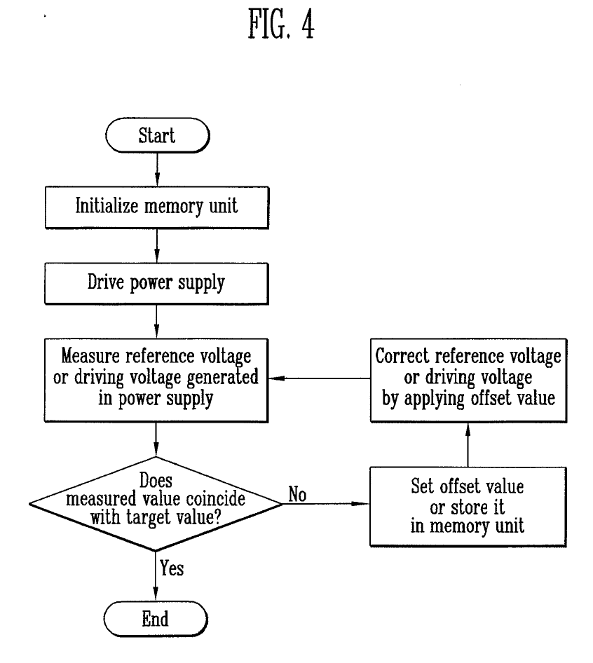

FIG. 2 is a block diagram showing one example of a power supply and a voltage correction device for correcting driving voltages generated by the power supply according to an embodiment of the present invention. In addition, FIG. 3 is a diagram exemplarily showing steps of generating driving voltages in a voltage generation register shown in FIG. 2.

First, referring to FIG. 2, the power supply 160 includes a voltage generation register 161, a memory unit 162, and a correction unit 163.

The voltage generation register 161 generates a plurality of driving voltages for driving the panel by using input power VCI. Here, the input power VCI may be a voltage source supplied to drive a driving integrated circuit (IC) from a module side of an exemplary device, such as the mobile phone set, etc.

The voltage generation register 161 generates various driving voltages for driving the panel while stepwise changing the voltage of the input power VCI by using an internal circuit element (not shown). For this, a plurality of voltage generation registers (not shown) for generating the plurality of driving voltages may be provided in the voltage generation register 161. For example, as shown in FIG. 3, the voltage generation register 161 may generate driving voltages such as reference voltage VREG1OUT of a ladder resistance for generating gray-scale voltages, gate high-level voltage VGH, and gate low-level voltage VGL by using the input power VCI.

Here, since the voltage change by the internal circuit element is limited, the voltage generation register 161 generates the reference voltage VREG1OUT of the ladder resistance, the gate high-level voltage VGH, and the gate low-level voltage VGL while changing the voltage stepwise by using the input power VCI. That is, as shown in FIG. 3, the voltage generation register 161 may generate a first reference voltage VCI1 by using the input power VCI and may generate the reference voltage VREG1OUT of the ladder resistance, the gate high-level voltage VGH, and the gate low-level voltage VGL by using the generated first reference voltage VCI1.

More specifically, the voltage generation register 161 may generate another reference voltage VREF by using the first reference voltage VCI1 generated from the input power VCI and may generate the reference voltage VREG1OUT of the ladder resistance by using the reference voltage VREF. Moreover, the voltage generation register 161 may generate a second reference voltage VLOUT1 by using the first reference voltage VCI1, generate a third reference voltage VLOUT2 and fourth reference voltage VLOUT3 by using the second reference voltage VLOUT1, and thereafter, generate the gate high-level voltage VGH and the gate low-level voltage VGL from the third reference voltage VLOUT2 and the fourth reference voltage VLOUT3, respectively.

The memory unit 162 stores offset values for correcting driving voltages (e.g., predetermined driving voltages) or reference voltages (e.g., predetermined reference voltages) for generating the driving voltages. For this, the memory unit 162 includes a memory device such as an EEPROM, etc.

The offset values are stored in the memory unit 162 by test equipment during testing of manufactured organic light emitting display devices. In particular, offset values related to the driving voltages that influence the image quality are stored in the memory unit 162. The driving voltages that influence the image quality may include, for example, the reference voltage VREG1OUT of the ladder resistance, the gate high-level voltage VGH, and the gate low-level voltage VGL shown in FIG. 3.

An offset value of the first reference voltage VCI1 used to stably generate the driving voltages such as the reference voltage VREG1OUT of the ladder resistance, the gate high-level voltage VGH, and the gate low-level voltage VGL may be stored in the memory unit 162. Further, an offset value for the reference voltage VREF for generating the reference voltage VREG1OUT of the ladder resistance or offset values for the gate high-level voltage VGH and the gate low-level voltage VGL may additionally be stored in the memory unit 162.

The corrector unit 163 corrects and outputs one or more driving voltages generated in the voltage generation register 161 by accessing the memory unit 162. More specifically, the correction unit 163 is supplied with driving voltages (e.g., predetermined driving voltages) or reference voltages (e.g., predetermined reference voltages) for generating the driving voltages from the voltage generation register 161, and corrects and outputs them by using the offset values stored in the memory unit 162.

For example, the correction unit 163 may be supplied with at least one of the first reference voltage VCI1 or the reference voltage VREF from the voltage generation register 161, and may correct and supply it to the voltage generation register 161 again by using the offsets of the first reference voltage VCI1 and/or the reference voltage VREF stored in the memory unit 162.

Then, since the voltage generation register 161 generates the driving voltages such as the reference voltage VREG1OUT of the ladder resistance or offset values for the gate high-level voltage VGH and the gate low-level voltage VGL by using the corrected first reference voltage VCI1 and/or the reference voltage VREF, the voltage generation register 161 may generate and output driving voltages having more stable values.

Further, the correction unit 163 is supplied with the gate high-level voltage VGH and the gate low-level voltage VGL from the voltage generation register 161. The correction unit 160 corrects the gate high-level voltage VGH and the gate low-level voltage VGL by accessing the memory unit 162 that stores the offset values for the voltages. The correction unit 163 corrects the voltages by using the offset values and thereafter, may immediately output them to the scan driver, etc.

Meanwhile, although not shown in FIG. 2, when driving voltages that are finally outputted to the scan driver, the data driver, the timing controller, and/or the display unit in the power supply 160 are not corrected by the correction unit 163, the driving voltages can immediately be outputted from the voltage generation register 161.

A voltage correction device 200 measures one or more driving voltages and/or reference voltages for generating the driving voltages, sets offset values by comparing the measured values with target values and stores them in the memory unit 162 of the power supply 160 during testing of the manufactured organic light emitting display devices. By this configuration, the voltage correction device 200 allows the power supply 160 to stably output the driving voltages.

For this, the voltage correction device 200 includes, for example, a voltage measurement unit 210 that measures one or more driving voltages generated in the voltage generation register 161 and/or reference voltages for generating the driving voltages, and an offset value setting unit 220 that compares the measured values from the voltage measurement unit 210 with the target values and sets corresponding offset values thereto, and stores them in the memory unit 162.

A luminance correction device, such as an MTP SET, may be used as the voltage correction device 200. In addition, various testing equipment capable of setting the offset values by measuring the voltages may be used. A driving voltage correction method of the organic light emitting display device using a voltage correction device will now be described in more detail.

FIG. 4 is a flowchart that shows a driving voltage correction method of an organic light emitting display device according to an embodiment of the present invention. Hereinafter, the driving voltage correction method of the organic light emitting display device will be described in detail by combining FIG. 4 with FIG. 2.

Referring to FIG. 4, first, the memory unit 162 is reset and initialized and thereafter, the power supply 160 is driven. In addition, the reference voltages or driving voltages generated in the power supply 160 are measured by using the voltage correction device 200, and the measured values are compared with the target values.

If a measured value and a target value are the same as each other or the measured value is included within an error range (e.g., a predetermined error range) of the target value, it is determined that the measured value coincides with the target value and the voltage correction is completed for that measured value. In addition, when a difference between the measured value and the target value is equal to or larger than the error range, an offset value corresponding thereto is set. For example, the offset value may be set to a voltage value corresponding to the difference between the measured value and the target value. Thereafter, the set offset value is stored in the memory unit 162 within the power supply 160 and the reference voltage or the driving voltage is corrected by applying the offset value by the correction unit 163.

Next, the reference voltage or driving voltage generated in the power supply 160 is measured again and the measured value is compared with the target value again. At this time, if the measured value coincides with the target value, the voltage correction is completed. If the measured value does not coincide with the target value, the correction step is performed again.

The correction is performed, for example, on each of the driving voltages that influence the image quality or the reference voltages for generating the driving voltages. For example, one or more voltages of the first reference voltage VCI1, the reference voltage VREF, the gate high-level voltage VGH, and the gate low-level voltage VGL may be corrected.

In particular, the first reference voltage VCI1 is a base voltage from which the reference voltage VREG1OUT of the ladder resistance, the gate high-level voltage VGH, and the gate low-level voltage VGL are generated. Thus, the first reference voltage VCI1 is generated as a stable value in order to improve the image quality. Accordingly, it is desirable that the first reference voltage VCI1 is corrected as a stable value equal to or similar to the target value.

Correcting the first reference voltage VCI1 includes: measuring the first reference voltage VCI1 generated in the voltage generation register 161 from the input power VCI, comparing a measured value of the first reference voltage VCI1 with a target value (e.g., a predetermined target value), and setting an offset value corresponding thereto; storing the offset value in the memory unit 162; correcting the first reference voltage VCI1 by applying the offset value stored in the memory unit 162 by the correction unit 163; and supplying the corrected first reference voltage VCI1 to the voltage generation register 161 and driving voltages of a panel that are based on the corrected first reference voltage VCI1 (e.g., the reference voltage VREG1OUT of the ladder resistance, the gate high-level voltage VGH, and the gate low-level voltage VGL).

Meanwhile, other reference voltages or driving voltages generated by the corrected first reference voltage VCI1 may additionally be corrected in order to more precisely correct the driving voltage. For example, when the reference voltage VREF is generated by using the corrected first reference voltage VCI1, and the reference voltage VREG1OUT of the ladder resistance for generating gray-scale voltages is generated by using the reference voltage VREF, the reference voltage VREF may additionally be an appropriate reference voltage for correction.

Correcting the reference voltage VREF may include: measuring the reference voltage VREF generated in the voltage generation register 161 by using the corrected first reference voltage VCI1, comparing a target value (e.g., a predetermined target value) with a measured value of the reference voltage VREF, and setting an offset value corresponding thereto; correcting the reference voltage VREF by applying the offset value set for the reference voltage VREF; and generating the reference voltage VREG1OUT of the ladder resistance by using the corrected reference voltage VREF.

Further, when the gate high-level voltage VGH and the gate low-level voltage VGL are generated by using the corrected first reference voltage VCI1, additional voltage correction for the generated gate high-level voltage VGH and gate low-level voltage VGL can be performed.

Correcting the gate high-level voltage VGH and the gate low-level voltage VGL may include: measuring the gate high-level voltage VGH and the gate low-level voltage VGL generated in the voltage generation register 161 by using the corrected first reference voltage VCI1, comparing target values (e.g., predetermined target values) with measured values of the gate high-level voltage VGH and the gate low-level voltage VGL, and setting offset values corresponding thereto; and correcting and outputting the gate high-level voltage VGH and the gate low-level voltage VGL by applying offset values set for the gate high-level voltage VGH and the gate low-level voltage VGL.

In the above-mentioned embodiment, only correction of the first reference voltage VCI1, the reference voltage VREF, the gate high-level voltage VGH, and the gate low-level voltage VGL is disclosed, but the present invention is not limited thereto. Other driving voltages that influence the image quality may also be corrected. For example, the voltage correction may be performed on the voltage of initialization power VINIT supplied to the pixels that is generated in the power supply 160.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
a display unit comprising a plurality of pixels located at crossing regions of scan lines and data lines;
a scan driver configured to supply scan signals to the scan lines;
a data driver configured to supply data signals to the data lines;
a timing controller configured to control the scan driver and the data driver; and
a power supply configured to supply a plurality of driving voltages to the display unit, the scan driver, the data driver, and the timing controller,
wherein the power supply is further configured to use input power to generate the plurality of driving voltages by:
using the input power to generate an uncorrected driving voltage;
correcting the uncorrected driving voltage by using an offset value stored during testing of the driving voltage generation, to generate a corrected driving voltage; and
outputting the corrected driving voltage.

2. The organic light emitting display device of claim 1, wherein the power supply comprises:
a voltage generation register configured to use the input power to generate the plurality of driving voltages;
a memory unit configured to store the offset value; and
a correction unit configured to access the memory unit to correct and output one or more of the driving voltages generated in the voltage generation register.

3. The organic light emitting display device of claim 2, wherein:
the voltage generation register is further configured to use the input power to generate a first reference voltage, and to use the first reference voltage to generate a second reference voltage of a ladder resistance, a gate high-level voltage, and a gate low-level voltage for generating gray-scale voltages, and
the memory unit is further configured to store an offset value for the first reference voltage.

4. The organic light emitting display device of claim 3, wherein:
the correction unit is further configured to use the offset value for the first reference voltage to correct the first reference voltage, and to supply the corrected first reference voltage to the voltage generation register, and
the voltage generation register is further configured to use the corrected first reference voltage to generate the second reference voltage of the ladder resistance, the gate high-level voltage, and the gate low-level voltage.

5. The organic light emitting display device of claim 3, wherein:
the voltage generation register is further configured to use the first reference voltage to generate a third reference voltage, and thereafter to use the third reference voltage to generate the second reference voltage of the ladder resistance, and
the memory unit is further configured to store an offset value for the third reference voltage.

6. The organic light emitting display device of claim 5, wherein:
the correction unit is further configured to use the offset value for the third reference voltage to correct the third reference voltage, and thereafter to supply the corrected third reference voltage to the voltage generation register, and
the voltage generation register is further configured to use the corrected third reference voltage to generate the second reference voltage of the ladder resistance.

7. The organic light emitting display device of claim 3, wherein the memory unit is further configured to store offset values for the gate high-level voltage and the gate low-level voltage.

8. The organic light emitting display device of claim 7, wherein the correction unit is further configured to use the offset values for the gate high-level voltage and the gate low-level voltage to correct the gate high-level voltage and the gate low-level voltage generated in the voltage generation register, and to output the corrected gate high-level voltage and the corrected gate low-level voltage to the scan driver.

9. A driving voltage correction method of an organic light emitting display device, the correction method comprising:
measuring a first reference voltage generated from an input power;
comparing a target value of the first reference voltage with the measured value of the first reference voltage and setting an offset value corresponding thereto;
storing the offset value;
correcting the first reference voltage by applying the offset value; and
generating driving voltage of a panel by using the corrected first reference voltage.

10. The correction method of claim 9, wherein a third reference voltage is generated by using the corrected first reference voltage, and a second reference voltage of a ladder resistance for generating gray-scale voltages is generated by using the third reference voltage.

11. The correction method of claim 10, further comprising:
measuring the third reference voltage;
comparing a target value of the third reference voltage with the measured value of the third reference voltage and setting an offset value for the third reference voltage;
correcting the third reference voltage by applying the offset value for the third reference voltage; and
generating the second reference voltage of the ladder resistance by using the corrected third reference voltage.

12. The driving voltage correction method of an organic light emitting display device of claim 9, wherein a gate high-level voltage and a gate low-level voltage are generated by using the corrected first reference voltage.

13. The correction method of claim 12, further comprising:
measuring the gate high-level voltage and the gate low-level voltage;
comparing target values of the gate high-level voltage and the gate low-level voltage with the measured values of the gate high-level voltage and the gate low-level voltage and setting offset values for the gate high-level voltage and the gate low-level voltage; and
correcting and outputting the gate high-level voltage and the gate-low level voltage by applying the offset values for the gate high-level voltage and the gate low-level voltage.
